(19) United States
(12) Patent Application Publication
(10) Pub. No.: US 2021/0264351 A1
(43) Pub. Date: Aug. 26, 2021

(54) REFILLABLE PET BOTTLE CODIFICATION FOR CONTAINER LIFECYCLE TRACEABILITY

(71) Applicant: AMCOR RIGID PACKAGING USA, LLC, Ann Arbor, MI (US)

(72) Inventor: Luis CARVALLO, Chelsea, MI (US)

(21) Appl. No.: 17/254,171

(22) PCT Filed: Jun. 20, 2019
(86) PCT No.: PCT/US2019/038133

§ 371 Date: Dec. 18, 2020

Related U.S. Application Data
(60) Provisional application No. 62/687,522, filed on Jun. 20, 2018.

(51) Int. Cl. G06Q 10/08; G06K 19/06; G06Q 30/00; G06K 7/10; G06K 7/14; G05B 19/4155; B65G 15/14; B65G 47/244; B23K 26/359; B65D 23/00

(52) U.S. Cl. CPC G06Q 10/087; G06Q 30/0201; G06Q 30/0185; G06K 19/06037; G06K 7/10445; G06K 7/1417; G06K 7/10861; G05B 19/4155; B65G 15/14; B65G 47/2445; B23K 26/359; B65D 23/00; G06K 2019/06271; G06K 2007/10504; G06K 19/06159

(57) ABSTRACT

A polymeric container including a code unique to the container that identifies the container. The code is on an inner surface of the container or on an outer surface of the container.

### CROSS-REFERENCE TO RELATED APPLICATION

This application claims the benefit and priority of U.S. Application No. 62/687,522, filed on Jun. 20, 2018, the entire disclosure of which is incorporated herein by reference.

### FIELD

The present disclosure relates to a refillable PET bottle with a code for tracking the lifecycle of the bottle, and a system for tracking the lifecycle of the bottle.

### BACKGROUND

This section provides background information related to the present disclosure, which is not necessarily prior art.

The practice of refilling and reusing PET bottles is becoming more and more common. A suitable way to track the lifecycle of such refillable PET bottles does not currently exist, however. While some bottle labels include identification codes, such label codes are inadequate because the labels are removed and discarded after the initial use of the bottle. An improved way of tracking a refillable bottle's lifecycle is thus needed. The present teachings advantageously provide for codification on a refillable PET bottle for tracking the lifecycle of the bottle, which provides numerous advantages as explained in detail herein and as one skilled in the art will appreciate.

### DRAWINGS

The drawings are for illustrative purposes only of select embodiments and not all possible implementations, and are not intended to limit the scope of the present disclosure.

FIG. 1 illustrates an exemplary container including a code unique to the container that identifies the container, the code arranged at an upper portion of the container;

FIG. 2 is a close-up view of the upper portion of the container of FIG. 1 including the code;

FIG. 3 illustrates the code alternatively located at a lower portion of the container;

FIG. 4A illustrates an exemplary method for printing the code on the container and adding the code to a container database prior to shipping the container;

FIG. 4B illustrates an exemplary method for refilling the container and updating the container database;

FIG. 5A is a perspective view of a system for reading codes off of a plurality of containers; and

FIG. 5B is a top view of the system for reading the codes off of the plurality of containers.

Corresponding reference numerals indicate corresponding parts throughout the several views of the drawings.

### DETAILED DESCRIPTION

Example embodiments will now be described more fully with reference to the accompanying drawings.

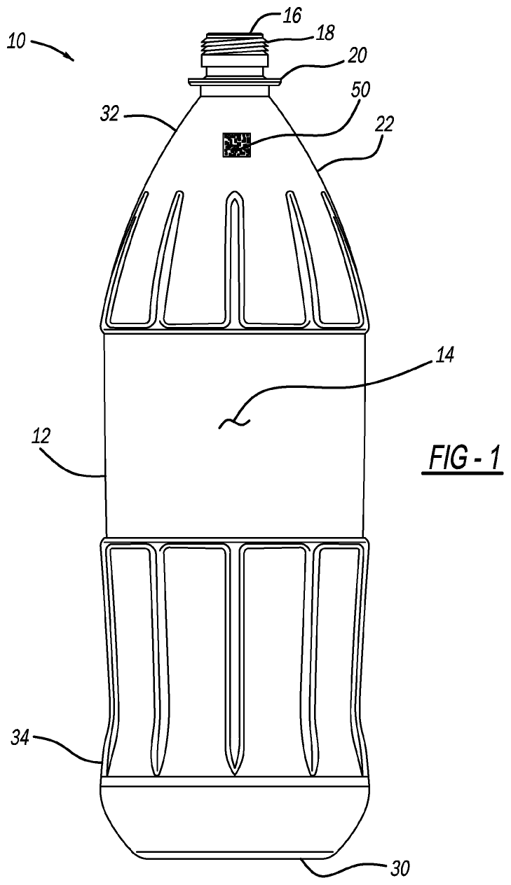

FIG. 1 illustrates an exemplary container 10 in accordance with the present disclosure. The container 10 may be formed in any suitable manner, such as by injection blow molding of a preform into a suitable container mold. The container 10 may have any suitable shape and size, and may be configured to store any suitable commodity therein. The container 10 may be made of any suitable material, such as any suitable polymeric material.

As illustrated in FIGS. 1-3, the container 10 includes a main body 12 defining an interior volume 14 in which the commodity is stored. A finish 16 defines an opening of the container 10. About the finish 16 are threads 18, which are configured to cooperate with the threads of any suitable closure to secure the closure to the finish 16 and close the opening defined by the finish 16. Below the finish 16 is a neck 20. A shoulder portion 22 extends outward from the neck 20. The shoulder 22 extends to the main body 12, and the main body 12 extends to a base 30. The base 30 is configured to support the container 10 upright on a planar surface. The base 30 may be any suitable base, such as a flexible base that is configured to flex to absorb vacuum within the container created during the blow-molding process. Thus the container 10 generally has an upper portion 32, which includes the shoulder 22 and an upper area of the main body 12, and a lower portion 34, which includes a lower portion of the main body 12 and the base 30.

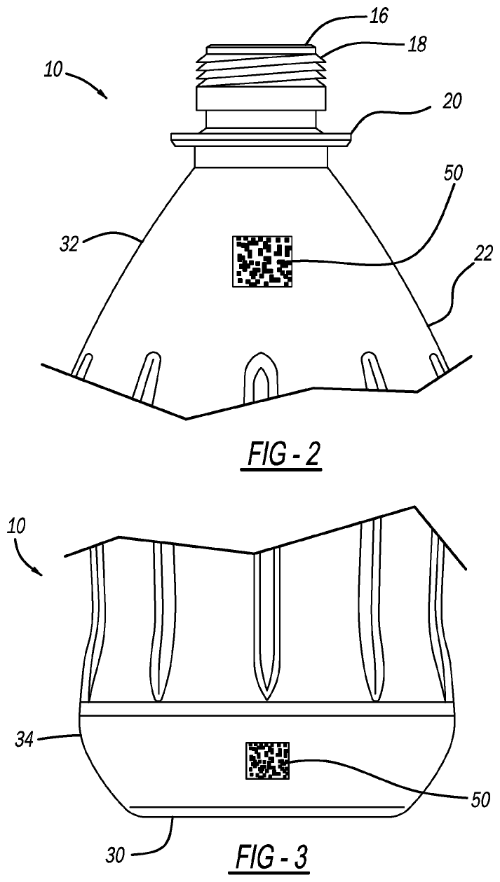

The container 10 further includes a unique identifier or code 50. In the example of FIGS. 1 and 2, the code 50 is arranged at the upper portion 32 of the container 10, and specifically at the shoulder 22. The code 50 may be arranged at any other suitable location of the container 10, such as at the lower portion 34 proximate to the base 30, as illustrated in FIG. 3. The code 50 is any suitable code unique to the container 10, which allows the container 10 to be identified and the history of the container 10 to be retrieved from any suitable database, as explained further herein. Suitable codes include, but are not limited to, the following: QR code; datamatrix code; Aztec code; PDF417 code; UPCIEAN code; code 128; and code 39.

The code 50 may be on an outer surface of the container 10, or on an inner surface of the container 10. The code 50 may be added to the container 10 in any suitable manner. For example, the code 50 may be printed onto the container 10 using any suitable printing device and method. The code 50 may also be etched into the inner or outer surface of the container 10 using any suitable etching device and method. For example, the code 50 may be laser etched into the outer surface or the inner surface of the container 10. Any suitable laser may be used, such as a D 320i I O blue laser.

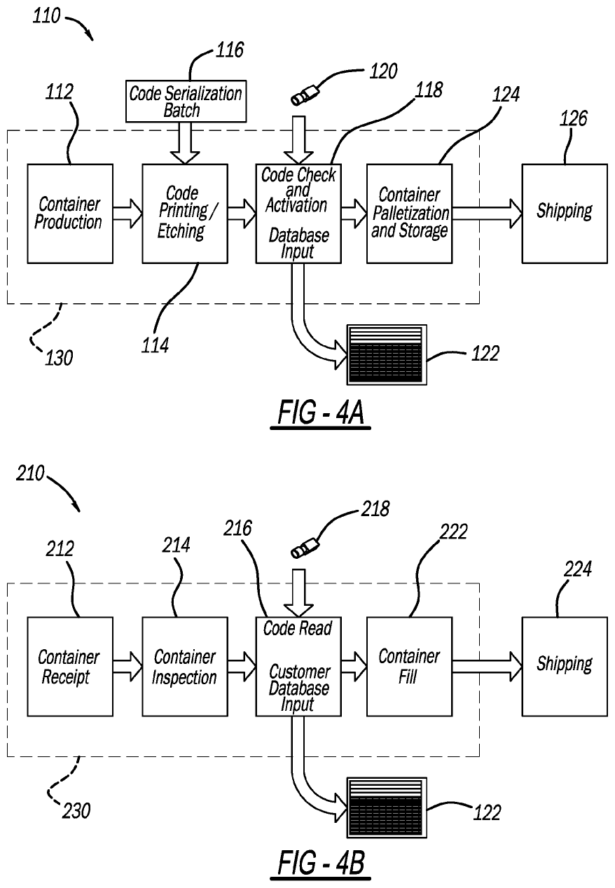

FIG. 4A illustrates an exemplary method for adding the code 50 to the container 10. The method 110 can be carried out by any suitable controller 130. In this application, including the definitions below, the term “controller” may be replaced with the term “circuit.” The term “controller” may refer to, be part of, or include processor hardware (shared, dedicated, or group) that executes code and memory hardware (shared, dedicated, or group) that stores code executed by the processor hardware. The code is configured to provide the features of the modules, controllers, and systems described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

At block 112, the container 10 is produced in any suitable manner, such as by injection blow molding, which may be controlled by the controller 130. At block 114, the code 50 is added to the container 10 in any suitable manner, such as by any suitable printing or etching process controlled by the controller 130. For example, the code 50 may be laser etched into the container 10 by laser etching.

The code 50 is a unique code retrieved from a code serialization batch 116 of a plurality of different codes 50. After the code 50 is added to the container 10, the code 50 is scanned by any suitable scanner 120, which may be controlled by the controller 130. The code 50 is then “activated” by adding the code 50 to any suitable database 122, and associating the code 50 with various information related to the container 10 using the controller 110. For example, the code 50 may be associated in the database 122 with manufacturing information, filling information, and/or field information.

The manufacturing information includes any suitable information related to the manufacturing of the container 10, such as the identity of the manufacturer, the date and time of manufacturing, the manufacturing lot, the material that the container 10 was formed of, the size of the container 10, the shape of the container 10, the manufacturing location of the container 10, and any other relevant production parameters. This manufacturing information is input to the database 122 at block 118 by the controller 130. The database 122 may be stored in memory associated with the controller 130, or at any suitable remote location. At block 124, the container 10 is arranged on a pallet with other containers including their own unique codes 50, and stored until the pallet of containers is shipped at block 126.

The container 10 is filled with any suitable commodity prior to, or after, shipping 126. For example, the container 10 may be filled prior to being arranged on a pallet at block 124. Alternatively, the container 10 may be filled after shipping, such as at a location other than the production location. Prior to or after filling, the filling information is added to the database 122 and associated with the code 50 by the controller 130. Any suitable filling information may be included. For example, the filling information may include a description of the commodity filled into the container 10, the date of the filling, the location of the filling, the identity of the filling entity, the filling lot, the number of times that the container 10 was previously filled (if any), and any other suitable filling parameters. The field information of the database 122 may include any suitable information, such as date, location, orbit, appearance, and promotional campaigns.

With reference to FIG. 4B, an exemplary method for refilling the container 10 is illustrated at reference numeral 210. The method 210 may be performed in any suitable manner, such as by a controller 230. After the container 10 has been emptied of its contents, the container 10 may be transported to any suitable recycling station. At block 212 the container 10 is received at the recycling station, and at block 214 the container 10 is inspected for any damage that may have occurred during prior use. At block 216, the code 50 is read by any suitable scanner 218, which may be controlled by the controller 230. At block 216 the database 122 is updated by the controller 230, such as with information related to recycling of the container 10. For example, the database 122 is updated with the recycling date, recycling location, recycling entity, recycling lot, condition of the container 10 as inspected at block 214, identification of the commodity that the container 10 is refilled with, and any other suitable information. At block 222 the container 10 is refilled, and at block 224 the container 10 is shipped. The method 210 for refilling the container 10 may be performed any suitable number of times depending on the lifespan of the container 10, and the condition of the container as inspected at block 214.

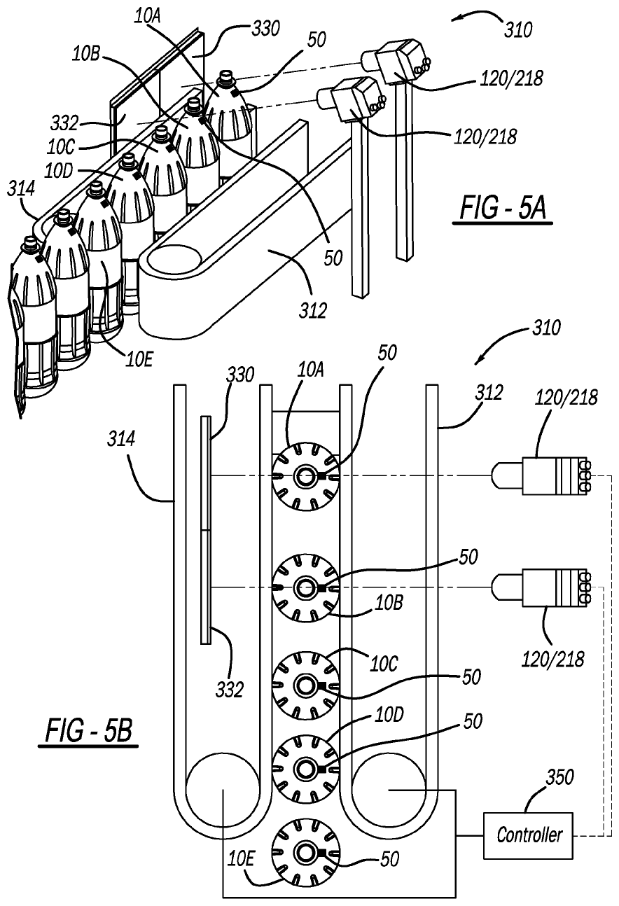

FIGS. 5A and 5B illustrate an exemplary system 310 for reading the code 50 off containers 10, such as at block 118 of the method 110 and/or at block 216 of the method 210. The system 310 includes a first belt 312 and a second belt 314. The belts 312 and 314 are controlled by any suitable controller 350. The belts 312 and 314 rotate to convey a plurality of containers 10A-10E, for example, along a path across a field of view of the scanners 120/218. Any suitable number of the scanners 120/218 may be included, such as two as illustrated in the example of FIGS. 5A and 5B. The belts 312 and 314 can be operated in any suitable manner by the controller 350 to rotate the containers 10A-10E until the code 50 faces either one of the scanners 120/218. For example, the belts 312 and 314 may be operated at different speeds, in different directions, or in any other suitable manner to turn the containers 110A-110E until the codes 50 thereof face the cameras 120/218.

With the code 50 of a particular container 10A-10E facing either one of the cameras 120/218, either one of the cameras 120/218 captures an image of the code 50 in any suitable manner, such as by directing a light beam to the code 50, which is arranged between the cameras 120/218 and a first reflector 330 or a second reflector 332. Thus the system 310 facilitates scanning of the code 50 by rotating the containers 10A-10E such that the codes 50 thereof face one or both of the cameras 120/218. The system 310 advantageously uses only two cameras 120/218, which is in contrast to prior systems requiring three or more cameras. Thus the system 310 is more cost effective and less complex to maintain and operate.

The present disclosure advantageously provides for the code 50 on the refillable PET container 10 for identifying the container 10, and systems 110 and 210 for using the code 50 to track the container's lifecycle. The code 50 can advantageously withstand the caustic wash and handling of the container 10 during its reusable lifecycle. Printing the code 50 on the inside of the container 10 advantageously protects the code 50 from every day bottle use.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A polymeric container comprising:
a code unique to the container that identifies the container, the code is on an inner surface of the container or on an outer surface of the container.

2. The polymeric container of claim 1, wherein the code is printed on the container.

3. The polymeric container of claim 1, wherein the code is etched into the container.

4. The polymeric container of claim 1, wherein the code is laser etched into the container.

5. The polymeric container of claim 1, wherein the code includes at least one of the following: a QR code; a datamatrix code; an Aztec code; a PDF417 code; a UPC/EAN code; a code 128; and a code 39.

6. The polymeric container of claim 1, wherein the code identifies the container in a database including the following information regarding the container: manufacturing information; filling information; and field information.

7. The polymeric container of claim 6, wherein the manufacturing information includes at least one of the following: manufacturing date, manufacturing lot, manufacturing location, and production parameters.

8. The polymeric container of claim 7, wherein the filling information includes at least one of the following: number of filling cycles, filling date(s), filling location(s), lot, and filling parameters.

9. The polymeric container of claim 8, wherein the field information includes at least one of the following: date, location, orbit, appearance, and promotional campaigns.

10. A system for reading a code on a polymeric container, the code is unique to the polymeric container, and the code is on an inner surface of the container or an outer surface of the container, the system comprising:
a first belt;
a second belt spaced apart from the first belt a distance sufficient for both the first belt and the second belt to contact the container when the container is arranged between the first belt and the second belt; and
a camera arranged along the first belt and the second belt, the camera configured to read the code off of the container as the first belt and the second belt convey the container along a distance;
wherein the first belt and the second belt are operated by a controller to rotate the container such that as the container passes the camera the code faces the camera and is visible to the camera.

11. The system of claim 10, wherein the first belt and the second belt are operated by the controller to move at different speeds or in different directions to rotate the container such that as the container passes the camera the code faces the camera and is visible to the camera.

12. The system of claim 10, wherein the camera is a first camera, and the system further comprises a second camera; and
wherein the system includes no more than two cameras.

13. The system of claim 10, wherein the code includes at least one of the following: a QR code; a datamatrix code; an Aztec code; a PDF417 code; a UPC/EAN code; a code 128; and a code 39.

14. The system of claim 10, wherein the code is printed on the container.

15. The system of claim 10, wherein the code is etched into the container.

16. The system of claim 10, wherein the code is laser etched into the container.

17. The system of claim 10, wherein the code identifies the container in a database including the following information regarding the container: manufacturing information; filling information; and field information.

18. The system of claim 17, wherein the manufacturing information includes at least one of the following: manufacturing date, manufacturing lot, manufacturing location, and production parameters.

19. The system of claim 18, wherein the filling information includes at least one of the following: number of filling cycles, filling date(s), filling location(s), lot, and filling parameters.

20. The system of claim 19, wherein the field information includes at least one of the following: date, location, orbit, appearance, and promotional campaigns.
